(19) United States
(12) Patent Application Publication
(10) Pub. No.: US 2026/0237188 A1
(43) Pub. Date: Aug. 13, 2026

(54) COMPUTING SYSTEM AND METHOD FOR PERFORMING A VISUAL LANGUAGE MODEL

(71) Applicant: LITE-ON TECHNOLOGY CORPORATION, TAIPEI CITY (TW)

(72) Inventors: Jiayi HO, TAIPEI CITY (TW); Ting Yu LIU, TAIPEI CITY (TW); Yi An CHEN, TAIPEI CITY (TW)

(21) Appl. No.: 19/351,510

(22) Filed: Oct. 7, 2025

Related U.S. Application Data
(60) Provisional application No. 63/757,879, filed on Feb. 13, 2025.

(51) Int. Cl. G06V 10/764; G06T 3/40; G06T 7/11; G06V 10/77; G06V 20/70; H04N 19/124

(52) U.S. Cl. CPC G06V 10/764; G06T 3/40; G06T 7/11; G06V 10/7715; G06V 20/70; H04N 19/124

(57) ABSTRACT

A computing system for performing a visual language model includes an edge device and a server. The edge device includes an image sensor and a processor. The image sensor is configured to capture an original image. The processor is configured to downscale the image, divide it into patches, embed the patches into vectors to generate image tokens, and encode the tokens. The server is configured to receive and decode the tokens, extract image features using a vision transformer, provide a user interface for receiving a prompt, process the prompt using a language model to generate text features, and analyze both image and text features to produce a multi-modal output.

### CROSS REFERENCE TO RELATED APPLICATIONS

This application claims the benefit of U.S. provisional application No. 63/757,879, filed Feb. 13, 2025, the entirety of which is incorporated by reference herein

### TECHNICAL FIELD

The present disclosure relates to artificial intelligence (AI), and in particular it relates to a computing system for performing a visual language model.

### BACKGROUND

Visual-language models (VLMs) are a class of artificial intelligence (AI) models designed to process and understand multimodal data that includes both visual and textual information. VLMs aim to enable machines to associate images with descriptive language and to perform complex tasks such as image captioning, visual question answering, and multimodal reasoning. With the rapid advancements in deep learning and the increasing availability of large-scale multimodal datasets, VLMs have made significant progress in terms of accuracy and applicability across various domains, including autonomous driving, healthcare imaging, robotics, and interactive AI systems.

In conventional implementations, deploying an artificial intelligence model on an edge device typically involves packaging a trained or pre-trained model into a file format that can be executed locally on the edge device, and invoking the model through an application programming interface (API) provided by the device. However, as the architectures and computational demands of VLMs continue to grow, executing such models directly on an edge device has become increasingly challenging, particularly for edge devices with mid-tier or low-tier computational capabilities.

Therefore, a computing system and method for performing a visual language model is needed to address the above issues.

### BRIEF SUMMARY

An embodiment of the present disclosure provides a computing system for performing a vision-language model. The system includes an edge device and a server. The edge device comprises an image sensor configured to capture an original image. The edge device comprises a processor configured to downscale the original image to generate a resized image. The processor further divides the resized image into multiple patches and embeds the patches into vectors to generate image tokens. These image tokens are then encoded using an encoder to produce compressed image tokens. The server is configured to receive the compressed image tokens from the edge device and decode them using a decoder to obtain reconstructed image tokens. The server then extracts image features from the reconstructed image tokens using a vision transformer. A user interface is provided through which a prompt is received. The prompt is processed by a language model to generate corresponding text features. The system analyzes both the image features and the text features to generate a multi-modal output, enabling support for various vision-language tasks such as visual question answering, image captioning, and image retrieval.

In some embodiments, the edge device further includes a memory. The processor is additionally configured to downscale the original image to generate a second resized image, and to store the second resized image along with a corresponding timestamp in the memory. The first resized image may be downscaled into a square shape for processing efficiency, while the second resized image may be downscaled in a manner that preserves the original aspect ratio, allowing for accurate reference or display purposes.

In some embodiments, the server is further configured to retrieve the second resized image stored in the memory of the edge device in response to generating the multi-modal output. The server then displays the retrieved second resized image on the user interface. Furthermore, when the received prompt includes temporal information, the server retrieves the second resized image that has a timestamp corresponding to the temporal information, thereby enabling time-specific image display and interaction

In some embodiments, the processor of the edge device is further configured to quantize the compressed image tokens and perform lossless compression on the quantized tokens to generate compressed data packets. The server is correspondingly configured to receive these compressed data packets, perform lossless decompression to reconstruct the quantized compressed image tokens, and then dequantize them to recover the original compressed image tokens.

Additionally, the processor of the edge device may encode the image tokens by compressing only the channel dimension of the tokens without reducing the total number of tokens.

In some embodiments, the encoder and decoder are components of an autoencoder. The multi-modal output generated by the system may include at least one of a textual description of the content of the original image or a classification result indicating a detected object or event within the image.

Furthermore, the server is configured to display the multi-modal output on the user interface and to receive user input selecting an action based on the displayed output.

An embodiment of the present disclosure provides a method for performing a vision-language model. The method includes, at an edge device, capturing an original image and downscaling the image using a processor to generate a resized image. The resized image is divided into multiple patches, which are embedded into vectors to generate image tokens. These tokens are then encoded by an encoder to produce compressed image tokens. At a server, the compressed image tokens are obtained from the edge device and decoded using a decoder to reconstruct the image tokens. Image features are extracted from the reconstructed tokens using a vision transformer. A user interface is provided to receive prompts, which are processed by a language model to generate corresponding text features. Finally, the method analyzes both the text features and image features to generate a multi-modal output, supporting various vision-language tasks.

In some embodiments, the method further includes downscaling the original image to generate a second resized image, which is stored along with an associated timestamp in a memory of the edge device. The first resized image may be downscaled to a square shape for processing purposes, while the second resized image is downscaled while preserving the original aspect ratio to maintain accurate visual representation.

Additionally, in response to generating the multi-modal output, the server retrieves the second resized image from the edge device's memory and displays it on the user interface.

In some embodiments, when the received prompt includes temporal information, the server retrieves the second resized image from the edge device's memory that has a timestamp corresponding to the temporal information.

In some embodiments, the method further includes quantizing the compressed image tokens at the edge device and performing lossless compression on the quantized tokens to generate compressed data packets. The server receives the compressed data packets, performs lossless decompression to reconstruct the quantized compressed image tokens, and then dequantizes the tokens to recover the original compressed image tokens.

In some embodiments, the image tokens are encoded by compressing only the channel dimension of the tokens without reducing the number of tokens.

In some embodiments, the encoder and decoder used to process the image tokens are components of an autoencoder.

In some embodiments, the multi-modal output comprises at least one of a textual description of the content of the original image or a classification result indicating a detected object or event within the original image.

In some embodiments, the method further includes displaying the multi-modal output on the user interface by the server, and receiving user input selecting an action based on the displayed multi-modal output.

### BRIEF DESCRIPTION OF THE DRAWINGS

The present disclosure can be more fully understood by reading the subsequent detailed description and examples with references made to the accompanying drawings, wherein:

FIG. 1 shows a computing system configured to perform steps of a visual language model;

FIG. 2A shows a first part of a computing method executed by the edge device;

FIG. 2B shows a second part of the computing method executed by the server;

FIG. 2C shows a data flow diagram of the computing method, integrating the first part and the second part; and

FIG. 3 shows a data flow representing the compression and transmission process between the edge device and the server.

### DETAILED DESCRIPTION

The following description is made for the purpose of illustrating the general principles of the disclosure and should not be taken in a limiting sense. The scope of the disclosure is best determined by reference to the appended claims.

To address the practical difficulties of running full-scale visual-language models (VLMs) on edge devices, the present disclosure proposes a decoupled model architecture in which the VLM is separated into a vision model and a language model. In this architecture, the edge device is responsible for capturing image data and executing the vision model locally, where the language model is executed to perform higher-level tasks such as understanding, tagging, or reasoning based on the visual input. This separation allows for improved deployment flexibility and reduced processing burden on the edge device.

Although this architecture alleviates the need to run the entire VLM on the edge device, several implementation issues must be addressed. As visual-language models continue to evolve in complexity, even the vision model component may exceed the processing capabilities of many edge devices, particularly those with limited hardware resources. In addition, transmitting high-dimensional visual features to the server may place a heavy burden on network bandwidth and introduce latency that can impair real-time performance. The present disclosure addresses these challenges through multiple embodiments, which will be described hereinafter.

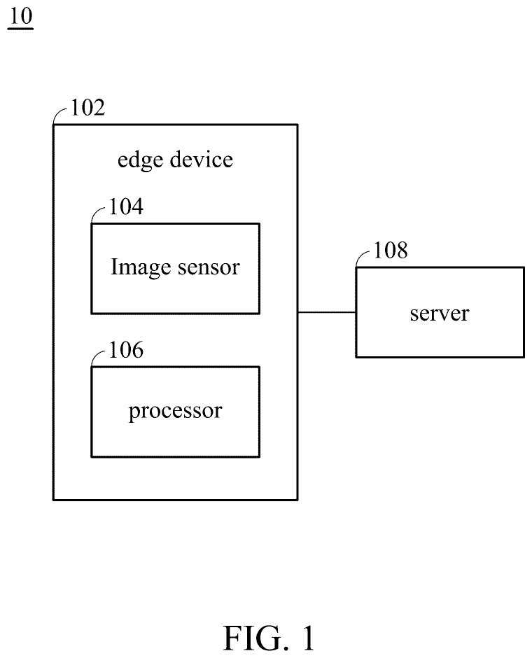

FIG. 1 illustrates a computing system 10 configured to perform steps of a visual language model, according to an embodiment of the present disclosure. The computing system 10 includes an edge device 102 and a server 108, which may be connected through a wired or wireless communication link, such as Ethernet, Wi-Fi, 5G, or other suitable network interfaces, but the present disclosure is not limited thereto.

The edge device 102 includes an image sensor 104. The image sensor 104 is configured to capture an original image of a scene. In some embodiments, the image sensor 104 may be implemented as a complementary metal-oxide-semiconductor (CMOS) image sensor, a charge-coupled device (CCD) image sensor, or other optical sensing technology, but the present disclosure is not limited thereto. The image sensor 104 may be integrated into various types of cameras, such as a digital still camera, a video camera, a smartphone camera module, a dashcam, or a surveillance camera, but the present disclosure is not limited thereto. Depending on application requirements, the image sensor 104 may support various resolutions, frame rates, and imaging enhancements, such as high dynamic range (HDR), low-light sensitivity, or multi-spectral sensing. In certain embodiments, the image sensor 104 may further include on-sensor processing circuitry for noise reduction, color correction, or preliminary compression.

The edge device 102 further includes a processor 106. The processor 106 may be implemented as a central processing unit (CPU), a graphics processing unit (GPU), a neural processing unit (NPU), a digital signal processor (DSP), a microcontroller unit (MCU), a field-programmable gate array (FPGA), an application-specific integrated circuit (ASIC), or a combination thereof, but the present disclosure is not limited thereto. The processor 106 is configured to perform local computation tasks such as image resizing, patch generation, token embedding, and token compression. In some embodiments, the processor 106 may include dedicated machine learning acceleration hardware, enabling efficient execution of deep neural network operations. The processor 106 may be integrated into the same package as the image sensor 104 (e.g., as part of a system-on-chip), or may be implemented as a separate module within the edge device 102, but the present disclosure is not limited thereto.

The server 108 is configured to receive processed visual data from the edge device 102 and perform additional computation tasks. The server 108 may be implemented as a cloud computing system, a local server, or a high-performance computing platform. The server 108 may include one or more CPUs, GPUs, tensor processing units (TPUs), or other AI accelerators optimized for large-scale model inference. In some embodiments, the server 108 is capable of executing transformer-based vision models and natural language processing models, enabling multi-modal reasoning over both visual and textual inputs, but the present disclosure is not limited thereto.

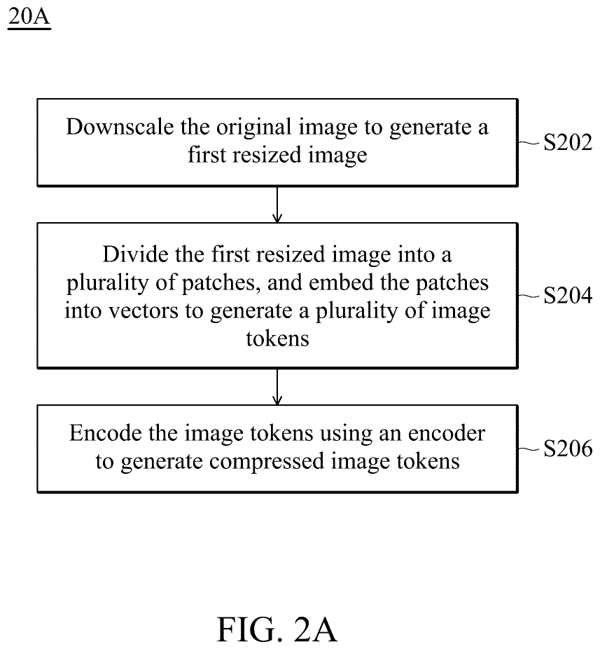

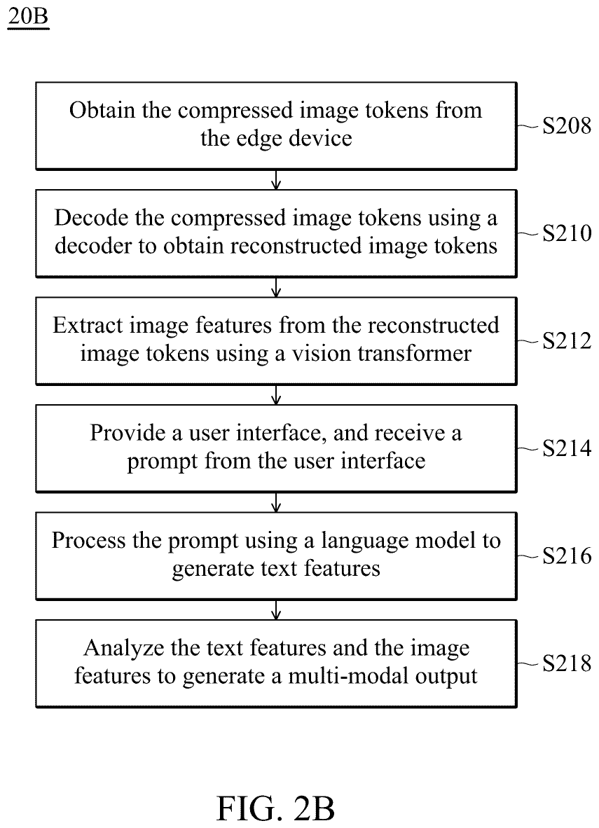

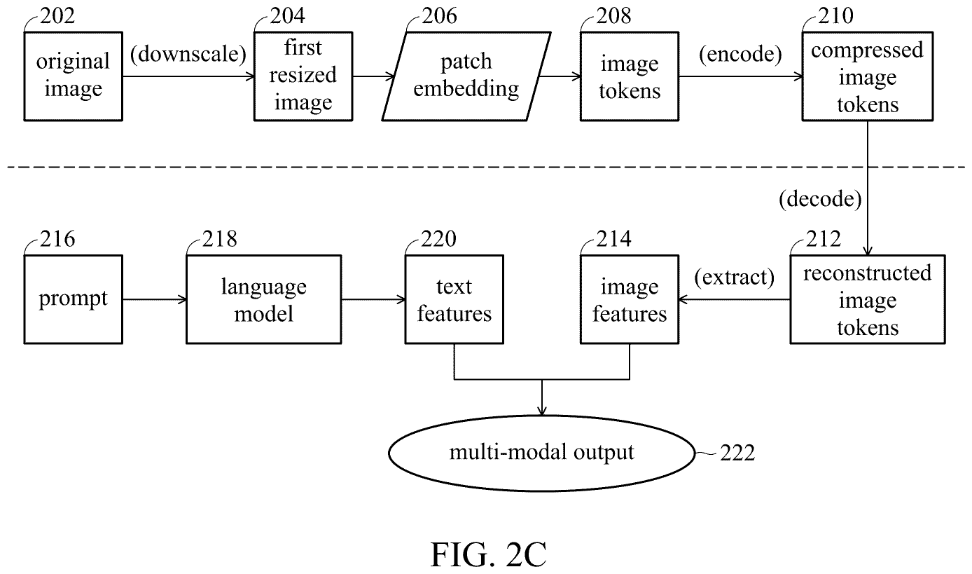

The steps executed by the computing system 10 for performing a VLM will be described in detail below with reference to FIG. 2A, FIG. 2B and FIG. 2C.

FIG. 2A illustrates a first part 20A of a computing method, according to an embodiment of the present disclosure. The first part 20A of the method is executed by the edge device 102. Corresponding to FIG. 2A, FIG. 2B illustrates a second part 20B of the computing method. The second part 20B of the method is executed by the server 108. Corresponding to FIG. 2A and FIG. 2B, FIG. 2C presents a data flow diagram of the computing method, including the first part 20A and the second part 20B. As shown in FIG. 2C, the upper portion corresponds to the steps performed in the first part 20A of the method, while the lower portion corresponds to the steps performed in the second part 20B. It is recommended to refer to FIG. 2A, FIG. 2B, and FIG. 2C together for better understanding of the embodiment.

At step S202, the edge device 102 downscales the original image 202, captured by the image sensor 104, to generate a first resized image 204. The downscaling operation may be performed using interpolation, subsampling, or other image resizing techniques. This step reduces image resolution to decrease computational complexity and transmission bandwidth requirements.

At step S204, the processor 106 divides the first resized image 204 into a plurality of patches and embeds each patch into a corresponding vector representation via a patch embedding process 206. This operation generates a plurality of image tokens 208, each representing localized visual content. In some embodiments, patch embedding may include linear projection, convolutional embedding, or positional encoding to preserve spatial information, but the present disclosure is not limited thereto.

At step S206, the image tokens 208 are encoded using an encoder to produce compressed image tokens 210. The encoder may be implemented as a transformer encoder, an autoencoder, or other neural network-based compression models. The purpose of compression is to reduce redundancy while retaining semantically meaningful information.

In some embodiments, the processor 106 of the edge device 102 is further configured to encode the image tokens 208 by performing compression along only a channel dimension of the image tokens, without reducing the total number of tokens. In this context, the channel dimension may correspond to the number of feature channels or latent dimensions associated with each token, such as those generated by a visual encoder or feature extraction network. By compressing only the channel dimension, the system can reduce the overall data size while maintaining the spatial resolution and positional granularity of the token sequence. Preserving the number of tokens ensures that fine-grained spatial information is retained, which may be important for downstream tasks such as object detection, image segmentation, or spatially precise reconstruction. This approach provides a balance between data reduction and preservation of critical visual details, enabling efficient transmission or storage without significantly degrading model performance in subsequent processing stages.

Referring to FIG. 2B and FIG. 2C, the second part 20B of the computing method is executed by the server 108.

At step S208, the server 108 obtains the compressed image tokens 210 from the edge device 102. The data transfer may occur over various communication channels, including wired Ethernet, Wi-Fi, cellular networks (e.g., 4G, 5G), or other wired or wireless communication protocols, but the present disclosure is not limited thereto. In some embodiments, the data may be encrypted during transmission to ensure privacy and prevent unauthorized access.

At step S210, the server 108 decodes the compressed image tokens 210 using a decoder to obtain reconstructed image tokens 212. The decoder may be implemented as a neural network-based module, such as a transformer decoder or a convolutional neural network decoder, which restores spatial and semantic details from the compressed representation. This step reverses the encoding performed at the edge device, enabling the server to work with a representation that retains essential visual information.

In some embodiments, the encoder and the decoder are implemented as respective components of an autoencoder architecture. The autoencoder may be configured to learn a compact latent representation of input data, such as image tokens, by training the encoder to map the input into a lower-dimensional latent space and the decoder to reconstruct the input from that latent representation.

The encoder may perform operations such as convolution, downsampling, or feature extraction to capture essential information while reducing data dimensionality, whereas the decoder may perform operations such as upsampling, deconvolution, or feature synthesis to reconstruct the original data or an approximation thereof, but the present disclosure is not limited thereto. By utilizing an autoencoder, the system can achieve efficient compression while preserving key structural and semantic features of the input, which can be beneficial for reducing transmission bandwidth, minimizing storage requirements, and maintaining high-quality reconstruction for subsequent processing tasks.

In certain embodiments, the encoder and decoder components of the autoencoder architecture are deployed across separate devices to optimize system performance and resource efficiency. Specifically, the encoder is executed on the edge device 102, while the decoder is executed on the server 108. This arrangement offers multiple advantages. The encoder, operating on the edge device, processes raw input data and maps it into a compact latent representation. Because the size of the latent representation is substantially smaller than the original high-dimensional input, transmitting this representation to the server significantly reduces bandwidth consumption and network load.

Moreover, the decoder, which reconstructs the data from the latent space, generally requires significant computational resources due to operations such as upsampling and feature synthesis. By assigning the decoder to the server, the system can leverage higher processing capabilities to perform these computations without overburdening the edge device. This division of tasks enables low-latency preprocessing on the edge while minimizing data transmission requirements and optimizing overall computational efficiency across the distributed system.

At step S212, the server 108 extracts image features 214 from the reconstructed image tokens 212 using a vision transformer. The vision transformer may employ self-attention mechanisms to capture both local and global contextual relationships in the visual data. This process generates high-dimensional image features that encode semantic content, object relationships, and spatial arrangements within the scene. In alternative embodiments, other feature extraction models, such as convolutional neural networks or hybrid CNN-transformer architectures, may be used, but the present disclosure is not limited thereto.

At step S214, the server 108 provides a user interface and receives a prompt 216 from the user interface. The user interface may be implemented as a web-based portal, a desktop application, or a mobile application, and may support text, voice, or gesture-based inputs, but the present disclosure is not limited thereto. The prompt 216 serves as the natural language query or instruction that guides the subsequent multi-modal analysis.

At step S216, the server 108 processes the prompt 216 using a language model 218 to generate text features 220. The language model 218 may be implemented as a transformer-based architecture trained on large-scale textual data, enabling it to represent the semantic meaning of the prompt in a high-dimensional embedding space. The generated text features may capture intent, contextual cues, and domain-specific terminology relevant to the visual data, but the present disclosure is not limited thereto.

At step S218, the server 108 analyzes the text features 220 and the image features 214 to generate a multi-modal output 222. This analysis may be performed using one or more multi-modal fusion techniques configured to integrate semantic information from both the linguistic and visual domains. In some embodiments, the server applies a cross attention fusion mechanism, in which attention weights are computed between the text features and image features to identify contextually relevant associations. In other embodiments, the server may employ a joint embedding model, projecting both the image and text features into a shared embedding space to enable similarity-based reasoning or execution of downstream tasks, such as image captioning, visual question answering, or retrieval.

In one implementation based on the Bootstrapping Language-Image Pre-training (BLIP) architecture, the image encoder and language model may first produce unimodal embeddings, which are then processed through a vision-language transformer that jointly attends to both modalities via cross-attention layers to produce a fused representation. The resulting multi-modal output 222 may encode both visual content and prompt-derived intent, thereby allowing the system to perform semantically aligned tasks.

In some embodiments, when the user does not provide any prompt 216, the system may default to executing an image captioning task based solely on the image features 214. In such cases, the server 108 may bypass the language model 218 and instead utilize a visual decoder or vision-language transformer configured to generate descriptive textual output conditioned only on the image features 214. This enables the system to autonomously produce a semantic summary or narrative of the visual content captured by the edge device.

The image captioning model may be pre-trained on paired image-text datasets and fine-tuned for domain-specific applications, such as surveillance, inspection, or situational awareness. By supporting both prompt-guided and prompt-free workflows, the system can dynamically adapt to user interaction levels while maintaining consistent utility and interpretability of the visual data. The present disclosure is not limited to any specific captioning model or architecture and may be implemented using transformer-based decoders, recurrent networks, or other generative models suitable for text generation tasks.

In some embodiments, the multi-modal output may include a textual description of the content of the original image, providing natural language sentences or paragraphs that describe objects, their attributes, spatial relationships, and contextual information within the scene. The multi-modal output may additionally or alternatively include a classification result that identifies a detected object or event within the original image, and may further provide a confidence score indicating the level of certainty in the classification. The multi-modal output may also encompass other types of combined visual linguistic inferences, such as answers to visual questions or object detection results that are conditioned on or filtered by the prompt.

In certain embodiments, the server 108 is further configured to display the multi-modal output 222 on a user interface, enabling the user to review the generated information in a visual or textual form. The server may also receive user input selecting an action based on the multi-modal output 222, such as initiating a follow up query, confirming a detected object, triggering an automated workflow, or storing the result for future reference, but the present disclosure is not limited thereto.

By integrating the generation, presentation, and interactive use of the multi-modal output, the computing system supports a continuous loop of analysis and user engagement, thereby enhancing system usability and responsiveness across various applications, including but not limited to automated reporting, surveillance monitoring, content-based search, and interactive query and response systems.

In some embodiments, the edge device 102 further includes a memory (not shown) configured to store intermediate or processed data. The memory may be implemented as volatile memory, such as dynamic random-access memory (DRAM) or static random-access memory (SRAM), or non-volatile memory, such as flash memory or a solid-state drive (SSD). The processor of the edge device may be further configured to downscale the original image to generate a second resized image.

The second resized image, along with a timestamp indicating the time at which the image was generated, may be stored in the memory. The timestamp may be obtained from an internal clock of the edge device, a network time protocol (NTP) service, or other timekeeping sources. Storing both the resized image and the corresponding timestamp allows the system to maintain temporal context for the captured image, which may be useful for subsequent analysis, synchronization with other sensor data, or historical record-keeping.

In some embodiments, the computing system 10 processes two resized versions of an original image. The first resized image 204 is downscaled to a square shape, which can facilitate uniform processing or analysis in subsequent computational steps. Meanwhile, the second resized image is downscaled while preserving the aspect ratio of the original image, thereby maintaining the original proportions and avoiding distortion. Preserving the aspect ratio in the second resized image ensures that features of the original image remain visually consistent, which may be beneficial for display or further applications such as image recognition, feature extraction, or further image processing tasks. The different resizing approaches applied to the two images enable the system to leverage the advantages of both uniform dimensions and faithful representation of the original image content.

In certain embodiments, the server 108 of the computing system is configured to perform additional steps in response to receiving a multi-modal output. Specifically, upon receiving the multi-modal output, the server 108 retrieves the second resized image from the memory of an edge device 102. This retrieval step allows the server 108 to access image data that has been previously downscaled while preserving the original aspect ratio, ensuring that the image maintains its visual fidelity.

Following retrieval, the server 108 is further configured to display the second resized image on a user interface. In this context, the display of the second resized image serves primarily as a means for users to visually access and review image content associated with the multi-modal output. Because the second resized image maintains the original aspect ratio, users are able to view the image with correct proportions, which is particularly important for tasks such as reviewing surveillance footage, browsing event-related images, or understanding the visual context corresponding to a prompt or system-generated result.

This functionality supports image recall or playback scenarios, allowing for efficient user interaction without requiring transmission of full-resolution images. The present disclosure is not limited to any specific display interface and may include web-based dashboards, desktop applications, or mobile interfaces.

In certain embodiments, the computing system operates such that when the received prompt includes temporal information, the server is further configured to retrieve from the edge device's memory the second resized image associated with a timestamp that corresponds to the temporal information contained in the prompt.

By matching the temporal information in the prompt with the stored timestamp of the resized image, the system ensures that the retrieved image reflects the specific point in time referenced by the prompt. This capability enables time-sensitive processing or analysis, such as reviewing images captured at a particular moment or synchronizing visual data with other temporally aligned sensor inputs. The inclusion of temporal context improves the accuracy and relevance of the server's response and supports applications requiring precise time-based image retrieval.

As a practical example, consider a retail store manager who discovers signs of tampering at the store entrance the morning after closing. Unsure of the exact time the incident occurred, the manager uses the system to input a general time-based prompt, such as “show footage from late last night.” The system matches this temporal request with stored image timestamps and retrieves a sequence of images captured between 2:00 AM and 4:00 AM. These images, displayed in the correct aspect ratio, allow the manager to quickly scan through relevant scenes.

In some embodiments, the system further supports broader prompts that combine time and visual conditions. For instance, the manager may input “find any unusual activity in the past 6 hours.” In response, the system applies object detection and scene analysis algorithms to identify image segments that deviate from normal patterns, such as detecting a person inside the store during non-operating hours. By aligning these visual anomalies with their associated timestamps, the system can automatically highlight time windows of interest. This intelligent filtering capability greatly reduces the need for manual review and provides timely insights for incident verification or escalation. Such a system may be valuable in various security-related scenarios, including loss prevention, after-hours monitoring, or assisting first responders in quickly locating visual evidence.

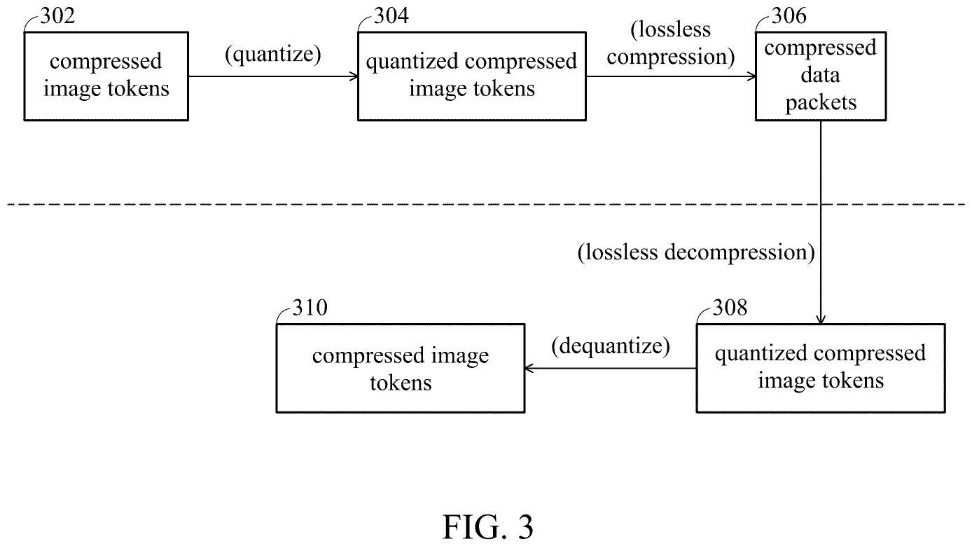

FIG. 3 illustrates a data flow representing the compression and transmission process between the edge device 102 and the server 108, according to a further embodiment of the present disclosure.

As shown in FIG. 3, in this embodiment, the processor 106 of the edge device 102 is further configured to quantize the compressed image tokens 302 (or the compressed image tokens 210), converting the tokens into discrete numerical levels to reduce data size while retaining essential information. Following quantization, the processor 106 performs lossless compression on the quantized compressed image tokens 304 to generate compressed data packets 306. The lossless compression ensures that no additional information is lost beyond the quantization step. The resulting compressed data packets 306 are then transmitted via a communication link to the server 108.

The communication link may include, for example, a wired Ethernet connection, a wireless local area network (WLAN) connection such as Wi-Fi, a cellular network connection such as 4G LTE or 5G NR, a satellite link, or a combination thereof. The type of communication link can be selected based on deployment conditions, required data throughput, latency tolerance, and network availability, but the present disclosure is not limited thereto.

Upon receiving the compressed data packets 306, the server 108 performs lossless decompression to exactly reconstruct the quantized compressed image tokens 308. In certain embodiments, the lossless decompression may be implemented using standard algorithms such as Huffman coding, Lempel-Ziv-Welch (LZW), DEFLATE, or other equivalent lossless compression schemes, but the present disclosure is not limited thereto. The choice of algorithm can depend on factors such as compression ratio, processing speed, and compatibility with the edge device.

Following decompression, the server 108 applies a dequantization process to the quantized compressed image tokens 308, thereby recovering the original compressed image tokens 310. In certain embodiments, the dequantization may involve mapping the quantized values back to a continuous or higher-resolution representation consistent with the original compressed image tokens 302. After dequantization, the server 108 may apply a decoding process to the compressed image tokens 310 to generate reconstructed image tokens 212, as illustrated in FIG. 2C. These reconstructed image tokens 212 may then be provided to subsequent modules, such as a vision-language model or an image recognition engine, to perform higher-level inference tasks.

It should be noted that the compressed image tokens 302 and the compressed image tokens 310 are denoted using the same terminology to emphasize their homogeneity in representation. Both tokens are derived from the same encoding scheme and are intended to serve as interchangeable entities for downstream decoding. However, due to the presence of quantization and dequantization processes, the reconstructed compressed image tokens 310 may not be bitwise identical to the originally generated compressed image tokens 302. Accordingly, while the tokens 302 and 310 are functionally equivalent in terms of format and usability, subtle discrepancies may arise from quantization-induced distortions, and such discrepancies may propagate into subsequent processing stages.

Furthermore, the quantized compressed image tokens 304 and 308 are, in principle, theoretically identical, since the intervening lossless compression and decompression processes do not alter the underlying data representation. For this reason, the same symbolic reference may be used to denote both entities. Nonetheless, different reference numerals are employed to highlight the distinction between pre-transmission and post-transmission instances, thereby clarifying the flow of data through the system.

As shown in FIG. 3, this data flow provides an efficient transmission mechanism by significantly reducing the amount of data that needs to be transmitted from the edge device 102 to the server 108. In particular, the application of quantization prior to lossless compression reduces the entropy of the data representation, thereby enabling higher compression ratios. The subsequent lossless compression and decompression processes can be implemented using algorithms with relatively low computational complexity, which makes the approach well-suited for deployment in resource-constrained edge devices. Accordingly, the system achieves a balance between reduced transmission bandwidth and manageable processing overhead. By performing quantization and lossless compression at the edge device 102, and corresponding lossless decompression and dequantization at the server 108, the system reduces communication bandwidth requirements while maintaining a representation of the image token data that is sufficient for downstream inference tasks. This architecture is particularly advantageous in scenarios where bandwidth is limited and computational efficiency is priority, mobile devices, IoT sensors, or other edge-based deployments.

To evaluate the impact of the disclosed compression scheme on downstream performance, an experimental validation was conducted using 1,000 samples drawn from a publicly available dataset. Each sample was separately compressed using a baseline JPEG method and the disclosed compression method, which employs an autoencoder with quantization to a 6-bit value range followed by lossless compression. The compressed results were then evaluated using a BLIP image retrieval test, where Recall@1 was computed as the primary performance metric. In addition, the compression ratio and transmission bandwidth usage (bitrate) were measured for both methods. Table 1 summarizes the results of this evaluation.

| | Method | |
|---|---|---|
| | | Autoencoder + |
| | JPEG | Quantization(6-bit) + |
| Evaluation metrics | Compression | Lossless Compression |
| Compression Ratio | 8.73x | 9.76x |
| Recall@1(BLIP Retrieval) | 85.69% | 86.39% |
| Bandwidth Usage (Bits/Second) | 414k | 370k |

The disclosed compression method achieves a higher compression ratio than JPEG, reducing transmission bandwidth from 414k bits/second to 370k bits/second, while maintaining Recall@1 performance in the BLIP image retrieval task. This performance is enabled by the autoencoder and normalization process, which preserves essential semantic information, combined with a subsequent lossless compression step that exploits statistical redundancy to further reduce transmission size. These evaluation metrics confirm that the proposed compression approach effectively reduces bandwidth usage without negatively impacting downstream vision-language model performance.

The computing system for performing a visual language model as disclosed herein implements a collaborative framework between edge devices and AI servers, wherein initial image analysis and compression is performed locally on the edge and compressed via the disclosed autoencoder method, followed by a subsequent lossless compression step to further optimize transmission efficiency. This modular and scalable architecture supports various vision-language tasks, providing a flexible, extensible, and computationally efficient solution that can be broadly applied across different VLM-based applications.

The following paragraphs further describe exemplary operations of the computing system 10, including the edge device 102 and the server 108, for generating and using elements such as compressed image tokens, reconstructed image tokens, image features, updated model parameters, and a multi-modal output, and clarify certain terms in a layered or iterative context with reference to FIGS. 1-3 and steps S202-S218. Certain embodiments further include optional operations for model parameter compression and structured representation, which may be implemented independently of the core token-based pipeline.

In some embodiments, the processor 106 of the edge device 102 performs local operations to downscale an original image, divide a first resized image into a plurality of patches, and embed the patches into vectors to generate image tokens (see S202-S204). The processor 106 then encodes the image tokens using an encoder to generate compressed image tokens (S206), wherein the encoding compresses only a channel dimension of the image tokens without reducing number of tokens so that positional granularity is preserved for subsequent processing. When employing the data flow of FIG. 3, the processor 106 quantizes the compressed image tokens into discrete numerical levels and performs lossless compression on the quantized compressed image tokens to form compressed data packets for transmission to the server 108. In some embodiments, the server 108 is further configured to generate updated model parameters by projecting the image data into a matrix-defined subspace derived from training iterations, wherein the subspace is constructed from a plurality of model parameter vectors and reduced using principal component analysis. The projection yields subspace coordinates, which are quantized using fixed bit precision and compressed using a model prior selected from a group consisting of Gaussian, Laplace, and Spike-and-Slab distributions. The structured latent representation may comprise a tensor format that retains both spatial and channel dimensions of the image data.

At the server 108, the server obtains the compressed image tokens (or compressed data packets) from the edge device 102 (S208); when compressed data packets are received, the server performs lossless decompression to reconstruct the quantized compressed image tokens and dequantizes the quantized compressed image tokens to recover the compressed image tokens prior to decoding as shown in FIG. 3. The server 108 decodes the compressed image tokens to obtain reconstructed image tokens (S210) and extracts image features from the reconstructed image tokens using a vision transformer (S212). The server 108 provides a user interface and receives a prompt from the user interface (S214), processes the prompt using a language model to generate text features (S216), and analyzes the text features and the image features to generate a multi-modal output (S218). In some embodiments consistent with FIG. 2B, analyzing the text features and the image features includes applying a cross-attention fusion mechanism that computes attention weights between the text features and the image features to produce a fused representation conditioned on the prompt, or applying a joint embedding model that projects the image features and the text features into a shared embedding space for similarity-based reasoning. The multi-modal output may include, for example, a textual description of the original image (image captioning), an answer to a visual question (visual question answering), or a ranked list of images retrieved from an image database (image retrieval). These examples illustrate distinct operational modes of the disclosed system—captioning operates without a user prompt, visual question answering depends on prompt-conditioned reasoning, and image retrieval involves database interaction—each demonstrating how the disclosed fusion process supports different vision-language tasks using the same disclosed procedures. In response to the multi-modal output, the server 108 retrieves a second resized image from a memory of the edge device 102 and displays the second resized image on the user interface; when the prompt includes temporal information, the server 108 retrieves the second resized image having a timestamp corresponding to the temporal information. Upon obtaining a subsequent set of compressed image tokens and/or receiving a subsequent prompt, the server 108 may re-apply these operations to generate a next multi-modal output in an iterative manner. In some embodiments, the updated model parameters are reconstructed by applying the subspace matrix to the quantized coordinates, yielding θ=θ_global+Mδ. In some embodiments, the transmitted bitstreams are formatted into a containerized archive that includes both the latent representation and the model update components, along with metadata such as a project identifier and per-object modules for runtime orchestration. In some embodiments, “temporal information” is to be understood as a time reference used by the server 108 to select the second resized image having the timestamp corresponding to the temporal information, “multi-modal output” is to be understood as an output derived from both the image features and the text features using the fusion operations described with reference to FIGS. 2B and 3, and “in response to” is to be understood as execution that occurs subsequent to generation of the multi-modal output and contingent upon that generation.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A computing system for performing a visual language model, comprising:
an edge device, comprising:
an image sensor, configured to capture an original image; and
a processor, configured to:
downscale the original image to generate a first resized image;
divide the first resized image into a plurality of patches, and embed the patches into vectors to generate a plurality of image tokens; and
encode the image tokens using an encoder to generate compressed image tokens; and
a server, configured to:
obtain the compressed image tokens from the edge device;
decode the compressed image tokens using a decoder to obtain reconstructed image tokens;
extract image features from the reconstructed image tokens using a vision transformer;
provide a user interface, and receive a prompt from the user interface;
process the prompt using a language model to generate text features; and
analyze the text features and the image features to generate a multi-modal output.

2. The computing system as claimed in claim 1, wherein the edge device further comprises a memory; and
wherein the processor is further configured to downscale the original image to generate a second resized image, and store the second resized image and a timestamp associated with the second resized image in the memory.

3. The computing system as claimed in claim 2, wherein the first resized image is downscaled to a square shape, and the second resized image is downscaled while preserving an aspect ratio of the original image.

4. The computing system as claimed in claim 2, wherein the server is further configured to:
in response to the multi-modal output, retrieve the second resized image from the memory of the edge device; and
display the second image on the user interface.

5. The computing system as claimed in claim 4, wherein in response to the prompt comprising temporal information, the server is further configured to retrieve the second resized image having the timestamp corresponding to the temporal information.

6. The computing system as claimed in claim 1,
wherein the processor of the edge device is further configured to quantize the compressed image tokens, and perform lossless compression on the quantized compressed image tokens to generate compressed data packets; and
wherein the server is further configured to:
receive the compressed data packets from the edge device;
perform lossless decompression on the compressed data packets to reconstruct the quantized compressed image tokens; and
dequantize the quantized compressed image tokens to recover the compressed image tokens.

7. The computing system as claimed in claim 1, wherein the processor of the edge device is further configured to encode the image tokens by compressing only a channel dimension of the image tokens without reducing number of tokens.

8. The computing system as claimed in claim 1, wherein the encoder and the decoder are components of an autoencoder.

9. The computing system as claimed in claim 1, wherein the multi-modal output comprises at least one of:
a textual description of content of the original image, or
a classification result indicating a detected object or event in the original image.

10. The computing system as claimed in claim 9, wherein the server is further configured to display the multi-modal output and to receive user input selecting an action based on the multi-modal output.

11. A method for performing a visual language model, comprising:
by an edge device:
capturing an original image;
downscaling the original image using a processor of the edge device to generate a first resized image;
dividing the first resized image into a plurality of patches, and embedding the patches into vectors to generate a plurality of image tokens; and
encoding the image tokens using an encoder to generate compressed image tokens;
by a server:
obtaining the compressed image tokens from the edge device;
decoding the compressed image tokens using a decoder to obtain reconstructed image tokens;
extracting image features from the reconstructed image tokens using a vision transformer;
providing a user interface, and receiving a prompt from the user interface;
processing the prompt using a language model to generate text features; and
analyzing the text features and the image features to generate a multi-modal output.

12. The method as claimed in claim 11, further comprising:
downscaling the original image to generate a second resized image; and
storing the second resized image and a timestamp associated with the second resized image in a memory of the edge device.

13. The method as claimed in claim 12, wherein:
the first resized image is downscaled to a square shape; and
the second resized image is downscaled while preserving an aspect ratio of the original image.

14. The method as claimed in claim 12, further comprising:
retrieving, via the server and in response to the multi-modal output, the second resized image from the memory of the edge device; and
displaying the second resized image on the user interface.

15. The method as claimed in claim 14, further comprising:
retrieving, via the server and in response to the prompt comprising temporal information, the second resized image having the timestamp corresponding to the temporal information.

16. The method as claimed in claim 11, further comprising:
by the edge device, quantizing the compressed image, and performing lossless compression on the quantized image tokens to generate compressed data packets;
by the server, receiving the compressed data packets from the edge device, performing lossless decompression on the compressed data packets to reconstruct the quantized compressed image tokens, and dequantizing the quantized compressed image tokens to recover the compressed image tokens.

17. The method as claimed in claim 11, wherein the image tokens are encoded by compressing only a channel dimension of the image tokens without reducing a number of tokens.

18. The method as claimed in claim 11, wherein the encoder and the decoder used to process image tokens are components of an autoencoder.

19. The method as claimed in claim 11, wherein the multi-modal output comprises at least one of:
a textual description of content of the original image, or
a classification result indicating a detected object or event in the original image.

20. The method as claimed in claim 19, further comprising:
by the server, displaying the multi-modal output on the user interface, and receiving user input selecting an action based on the multi-modal output.
